(19) United States
(12) Patent Application Publication
(10) Pub. No.: US 2019/0087820 A1
(43) Pub. Date: Mar. 21, 2019

(54) FALSE DECLINE ALERT NETWORK

(71) Applicant: MasterCard International Incorporated, Purchase, NY (US)

(72) Inventors: Peter J. Groarke, Dublin (IE); Ahmed Hosny, Dublin (IE)

(21) Appl. No.: 15/707,706

(22) Filed: Sep. 18, 2017

(51) Int. Cl. G06Q 20/40

(52) U.S. Cl. CPC G06Q 20/4016; G06Q 20/405

(57) ABSTRACT

A method of operating a false decline alert network is implemented using an alert computing device. The method includes receiving a decline message from an issuer computing device via a non-transaction message communication channel, wherein the decline message includes decline data identifying a declined transaction initiated by an accountholder. The method also includes identifying, based upon the decline data, an upstream party to the declined transaction, and transmitting a false decline alert to a receiving computing device associated with the upstream party. The false decline alert includes (i) an identifier of the accountholder and/or a corresponding account associated with the declined transaction, and (ii) control instructions causing the receiving computing device to update at least one decline model with the identifier, wherein updating the at least one decline model counteracts an effect of the declined transaction on at least one future transaction involving the accountholder and/or the corresponding account.

### BACKGROUND

This disclosure relates generally to the field of electronic account authorization and authentication systems. More specifically, the disclosure relates to a false decline alert network implemented after an initial payment transaction is declined to revise authorization rules in subsequent transactions.

As a matter of background, accountholders may use a variety of methods to perform payment transactions to purchase goods and services at a variety of merchants. These methods include use of plastic payment cards and personal computing devices (also known as accountholder computing devices) at point of sale (POS) devices operated by merchants. A payment processor computing device processes the payment transactions over a processing network. Where accountholder computing devices are used, data may be transmitted between an accountholder computing device and the payment processor computing device during a transaction. Data transmissions may include transaction data, which refers to data collected by the payment processor computing device. Transaction data may include authentication data, such as a username, account number, or the like. Transaction data may also include transaction date/time, transaction amount, merchant identifiers, or the like.

Any party to the transaction, including the merchant, the merchant's bank (“acquirer”), the payment processor computing device, and the issuer, may choose to decline the accountholder's transaction. For instance, any of these parties may employ one or more authentication or anti-fraud engines configured to reduce fraudulent transactions, particularly by declining suspected fraudulent transactions. These engines may use a plurality of rules, models, black lists, white lists, and/or other inputs or techniques to determine whether a transaction should be accepted or declined.

When a non-fraudulent transaction is declined for being suspected as fraud, this decline is known as a “false decline.” False declines are costly to all parties involved in a transaction and are frustrating to the accountholder whose transaction is declined. Moreover, a false decline is often indistinguishable from a “true” decline in the anti-fraud engines employed by the parties to the transaction. Accordingly, having a transaction declined in a false-decline scenario may increase the likelihood that future transactions are declined, as the anti-fraud engines may assume that a false decline was a true fraudulent transaction rightfully declined.

### BRIEF DESCRIPTION

In one aspect, a method of operating a false decline alert network is provided. The method is implemented using an alert computing device. The method includes receiving a decline message from an issuer computing device via a non-transaction message communication channel. The decline message includes decline data identifying a declined transaction initiated by an accountholder. The method also includes identifying, based upon the decline data, at least one upstream party to the declined transaction. The method further includes transmitting a false decline alert to a receiving computing device associated with the at least one upstream party. The false decline alert includes (i) an identifier of at least one of the accountholder and a corresponding account associated with the declined transaction, and (ii) control instructions causing the receiving computing device to activate and update at least one decline model with the identifier. Updating the at least one decline model counteracts an effect of the declined transaction on at least one future transaction involving the at least one of the accountholder and the corresponding account.

In another aspect, an alert computing device for implementing a false decline alert network is provided. The alert computing device includes a processor in communication with a memory device. The processor is programmed to receive a decline message from an issuer computing device via a non-transaction message communication channel. The decline message includes decline data identifying a declined transaction initiated by an accountholder. The processor is also programmed to identify, based upon the decline data, at least one upstream party to the declined transaction, and transmit a false decline alert to a receiving computing device associated with the at least one upstream party. The false decline alert includes (i) an identifier of at least one of the accountholder and a corresponding account associated with the declined transaction, and (ii) control instructions causing the receiving computing device to activate and update at least one decline model with the identifier. Updating the at least one decline model counteracts an effect of the declined transaction on at least one future transaction involving the at least one of the accountholder and the corresponding account.

In yet another aspect, a non-transitory computer readable medium that includes computer executable instructions for implementing a false decline alert network. When executed by an alert computing device including a processor in communication with a memory device, the computer executable instructions cause the alert computing device to receive a decline message from an issuer computing device via a non-transaction message communication channel. The decline message includes decline data identifying a declined transaction initiated by an accountholder. The computer executable instructions also cause the alert computing device to identify, based upon the decline data, at least one upstream party to the declined transaction. The computer executable instructions further cause the alert computing device to transmit a false decline alert to a receiving computing device associated with the at least one upstream party. The false decline alert includes (i) an identifier of at least one of the accountholder and a corresponding account associated with the declined transaction, and (ii) control instructions causing the receiving computing device to activate and update at least one decline model with the identifier. Updating the at least one decline model counteracts an effect of the declined transaction on at least one future transaction involving the at least one of the accountholder and the corresponding account.

### BRIEF DESCRIPTION OF THE DRAWINGS

FIGS. 1-4 show example embodiments of the methods and systems described herein.

FIG. 1 is a schematic diagram illustrating an example false decline alert network operating in conjunction with but independently from an example multi-party transaction processing system for enabling payment card transactions.

FIG. 2 illustrates an example configuration of a user system, such as an accountholder computer device, that may be used in the false decline network and/or the transaction processing system shown in FIG. 1.

FIG. 3 illustrates an example configuration of a server system that may be used in the false decline network and/or the transaction processing system shown in FIG. 1.

FIG. 4 shows an example method flow for operating a false decline alert network.

Like numbers in the Figures indicate the same or functionally similar components.

### DETAILED DESCRIPTION

The present disclosure relates to a false decline alert network. The false decline alert network includes at least one computing device (an “alert computing device”) in communication with one or more parties in a transaction processing system (e.g., the merchant, acquirer, payment processing computing device, and/or issuer). The false decline alert network operates in conjunction with but independently of the transaction processing system to process reports of false declines and distribute corrective information to one or more parties in the transaction processing system. The corrective information may be incorporated into the respective anti-fraud engines of each party of the transaction processing system to (i) counteract or eliminate the effect of having a false decline associated with an accountholder and/or payment device, (ii) remove any report of a false decline from the anti-fraud engines, and/or (iii) reduce future false declines.

In the exemplary embodiment, an authorized accountholder attempts (with a merchant point of sale (POS) computing device) a transaction that is declined. In one embodiment, the transaction is declined by one party to the transaction processing system for failure to satisfy an authorization and/or authentication rule set and/or implemented by an anti-fraud engine (or other components) of that party. The accountholder may be notified of the decline at the POS or at their user computing device at which they are conducting the transaction. In some cases, where the issuer has declined the transaction, the issuer may transmit a decline notification to the accountholder's user computing device. The decline notification includes some details describing the declined transaction and may provide the accountholder an opportunity to “salvage” the declined transaction. For instance, the accountholder may be able to respond to the decline notification (e.g., providing extra authentication of the transaction), and the decline may be reversed. However, even where a decline notification is transmitted to the accountholder, the transaction may still be declined (e.g., if the accountholder does not see the notification or does not respond within a predetermined period of time).

In response to a declined transaction, the accountholder contacts the issuer associated with the account used to initiate the declined transaction. The accountholder provides information associated with the declined transaction, “accountholder decline data,” such as an account identifier of the account, a transaction amount of the declined transaction, a date and/or time of the declined transaction, and/or the merchant with which the declined transaction was initiated. The accountholder may provide (and/or the issuer may request) additional data, such as authentication data, to ensure that the accountholder is an authorized accountholder.

The issuer then transmits the accountholder decline data to the false decline alert network. More specifically, the issuer transmits the accountholder decline data to an alert computing device associated with the false decline alert network. In the example embodiment, the issuer communicates the accountholder decline data to the alert computing device over a non-transaction message communication channel, or over a communication channel other than that reserved for transaction messages (e.g., ISO-8583 network messages). For example, the issuer may communicate the accountholder decline data to the alert computing device via telephone message, via an email message, via text message, and/or via an internet protocol (IP)-based message, such as over an Application Programming Interface (API) communicatively coupling the alert computing device to an issuer computing device of the issuer.

Based upon the accountholder decline data, the alert computing device identifies the upstream parties to the declined transaction, such as the merchant, acquirer, and payment processing computing device (i.e., those parties “upstream” of the issuer in the transaction processing system). The alert computing device generates a false decline alert including one or more identifiers of the accountholder and/or the corresponding account for transmittal to the upstream parties to the declined transaction. The false decline alert further includes control instructions that cause the receiving computing device to activate and incorporate the accountholder decline data into one or more anti-fraud engines, or the decline models used thereby. Updating the decline models, in the example embodiment, counteracts an effect of the declined transaction on at least one future transaction involving the accountholder and/or the corresponding account used in the declined transaction.

In some cases, the transaction is declined by one of the upstream parties, such as the merchant, acquirer, or payment processing computing device. Each of these upstream parties may implement its own anti-fraud engine with its own decline model(s). Accordingly, only the party that declined the transaction knows the precise reason for the decline. In response to receiving the false decline alert, the particular upstream party that declined the transaction may transmit a message back to the alert computing device, the message including a decline reason code associated with the declined transaction. The decline reason code indicated the reason the transaction was declined (e.g., bad authorization details, unable to authenticate, rigorous anti-fraud/decline models, etc.). The alert computing device then transmits a notification message to the issuer, the notification message including the decline reason code. The notification message may further include control instructions causing the issuer computing device to activate and update one or more records associated with the accountholder and/or the corresponding account. For instance, if the decline reason code indicates that the authorization details were inaccurate or outdated, the issuer may update a record associated with the account to indicate that the authorization details being used by the accountholder are inaccurate or outdated. In response, the issuer may initiate communication with the accountholder to ensure that the accountholder has the proper authorization credentials for future transactions.

In other cases, the transaction is declined by the issuer itself. In such cases, the upstream parties to the transaction receive various transaction messages, such as decline transaction messages, indicating that the issuer declined the transaction. Those upstream parties may interpret (in some cases, incorrectly) that this decline was the result of a fraudulent transaction and may blacklist that accountholder and/or account, or otherwise negatively affect the outcomes of decline modelling associated with the accountholder and/or account. In these cases, the alert computing device may transmit the false decline alert not only to the upstream parties (causing those parties to update their decline models) but also to the issuer computing device. The control instructions in the false decline alert cause the issuer computing device to activate and update at least one decline model associated with the accountholder, and/or to update one or more records associated with the accountholder and/or the account. Such updating may reduce the likelihood that the issuer will decline a future transaction and/or may cause the issuer to initiate communication with the accountholder to ensure the accountholder has the proper account details to prevent further future declines (e.g., making sure authorization credentials are up to date, authentication details remain accurate, etc.).

The technical problems addressed by this system include at least one of: (i) inability of anti-fraud engines to distinguish between true fraudulent decline and false declines, (ii) inability of parties to a transaction to compensate for false declines in decline models, (iii) inability of downstream parties to a transaction to receive notifications of false declines, and (iv) inability of issuer computing devices to update their decline models (and/or the decline models of other parties) in a timely manner in order to approve reattempted transactions by a legitimate accountholder.

The methods and systems described herein may be implemented using computer programming or engineering techniques including computer software, firmware, hardware, or any combination or subset thereof, wherein the technical effects may be achieved by: (a) receiving a decline message from an issuer computing device via a non-transaction message communication channel, wherein the decline message include decline data identifying a declined transaction initiated by an accountholder; (b) identifying, based upon the decline data, at least one upstream party to the declined transaction; and (c) transmitting a false decline alert to a receiving computing device associated with the at least one upstream party, the false decline alert including (i) an identifier of at least one of the accountholder and a corresponding account associated with the declined transaction, and (ii) control instructions causing the receiving computing device to activate and update at least one decline model with the identifier, wherein updating the at least one decline model counteracts an effect of the declined transaction on at least one future transaction involving the at least one of the accountholder and the corresponding account.

The resulting technical benefits achieved by this system include at least one of: (i) a new network independent of the transaction processing system to process false declines, (ii) generation of false decline alerts that facilitate counteracting negative effects of false declines with each party to a transaction, and (iii) improved electronic transaction processing involving fewer declines, thereby leading to decreases in unnecessary network traffic and computer processing.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable storage medium. In an example embodiment, the system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application in industrial, commercial, and academic applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

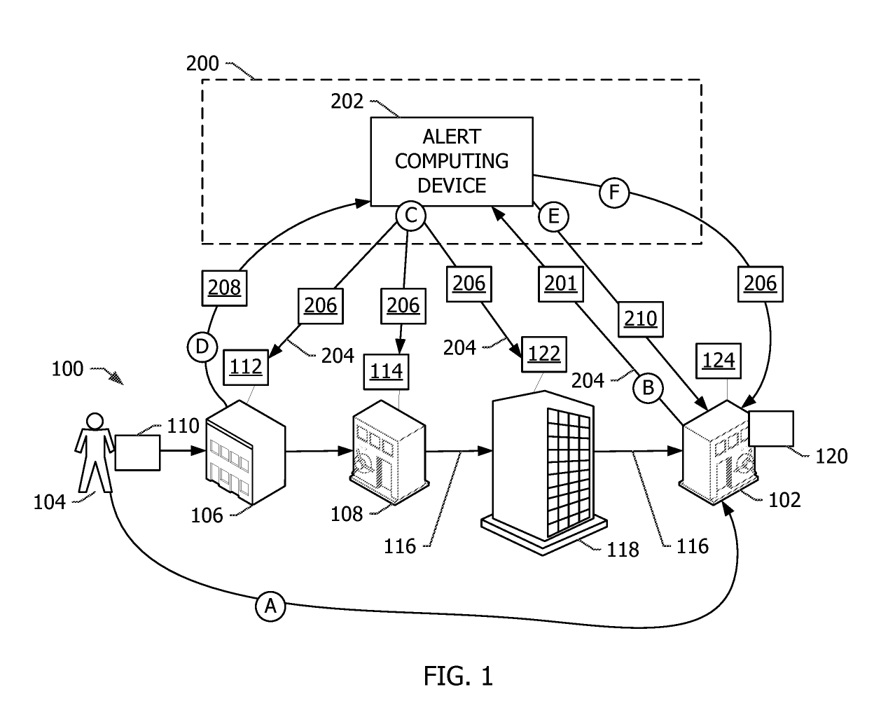

FIG. 1 is a schematic diagram illustrating an example false decline network 200 operating in conjunction with but independently from an example multi-party transaction processing system 100 for enabling payment card transactions. In a typical transaction processing system 100, a financial institution called the “issuer” 102 issues a transaction card, such as a credit card, to the accountholder or accountholder 104, who uses the transaction card to tender payment for a purchase from a merchant 106. To accept payment with the transaction card, merchant 106 must normally establish an account with a financial institution that is part of transaction processing system 100. This financial institution is usually called the “merchant bank,” the “acquiring bank,” or the “acquirer” 108.

In one embodiment, accountholder 104 tenders payment for a purchase using a transaction card at a transaction processing device 110 (e.g., a point of sale device at a physical merchant 106 or a user computing device of accountholder 104 used to access an online merchant 106). In some embodiments, merchant 106 includes a corresponding anti-fraud engine 112 that uses decline models to determine whether to proceed with the transaction or to decline the transaction. Decline models take into account various transaction attributes, such as an account identifier, transition amount, merchant identifier, transaction date/time, transaction environment (e.g., e-commerce or online, mail order/telephone order, physical card present), and/or card or accountholder verification/authentication details, to make such a determination. Decline models may also take into account various other data, such as stored data associated with accounts, accountholders, locations, parties to a transaction, and/or other data, to make such determinations. Anti-fraud engine 112 may run one or more such decline models and, based on the output therefrom, recommend to merchant 106 whether to accept or decline the transaction.

If merchant 106 approves or accepts the transaction, merchant 106 requests authorization from acquirer 108 for the transaction amount of the purchase. The request may be performed through transaction processing device 110 by reading account information from a magnetic stripe, a chip, or embossed characters on the transaction card, or by accepting account information input to transaction processing device 110 by accountholder 104. Transaction processing device 110 and/or merchant 106 communicates electronically with acquirer computing device(s) of acquirer 108. In some embodiments, acquirer 108 includes a corresponding anti-fraud engine 114 that uses its own decline models, as described above, to determine whether to proceed with the transaction or to decline the transaction.

If acquirer 108 approves or accepts the transaction, using an interchange network 116 (e.g., a payment processing computing device 118 of interchange network 116), computers of acquirer 108 will communicate with computers of issuer 102 to determine whether the accountholder's account 120 is in good standing and whether the purchase is covered by the accountholder's available funds or credit line. In some embodiments, payment processing computing device 118 includes a corresponding anti-fraud engine 122 that uses its own decline models, as described above, to determine whether to proceed with the transaction or to decline the transaction. Additionally or alternatively, issuer 102 includes a corresponding anti-fraud engine 124 that uses its own decline models, as described above, to determine whether to proceed with the transaction or to decline the transaction. Based on these determinations, the request for authorization will be declined or accepted by issuer 102. If the request is accepted, an authorization code is issued to merchant 106.

In the illustrated embodiment, accountholder 104 attempts a transaction that is declined. In response to the declined transaction, accountholder 104 contacts (A) issuer 102 associated with account 120 used to initiate the declined transaction. Accountholder 104 provides information associated with the declined transaction, “accountholder decline data” 201, such as an account identifier of account 120, a transaction amount of the declined transaction, a date and/or time of the declined transaction, and/or merchant 106 with which the declined transaction was initiated. Accountholder 104 may provide (and/or issuer 102 may request) additional data, such as authentication data, to ensure that accountholder 104 is an authorized accountholder.

Issuer 102 transmits (B) accountholder decline data 201 to false decline alert network 200. More specifically, issuer 102 transmits accountholder decline data 201 to an alert computing device 202 associated with and/or integral to false decline alert network 200. In the example embodiment, issuer 102 communicates accountholder decline data 201 to alert computing device 202 over a non-transaction message communication channel 204 of false decline alert network 200, or over a communication channel 204 other than network 116 reserved for transaction messages (e.g., ISO-8583 network messages). For example, issuer 102 may communicate accountholder decline data 201 to alert computing device 202 via telephone message, via an email message, via text message, and/or via an internet protocol (IP)-based message, such as over an Application Programming Interface (API) communicatively coupling alert computing device 202 to an issuer computing device (not specifically shown) of issuer 102.

Based upon accountholder decline data 201, alert computing device 202 identifies upstream parties to the declined transaction, such as merchant 106, acquirer 108, and payment processing computing device 118 (i.e., those parties “upstream” of issuer 102 in transaction processing system 100). Alert computing device 202 generates a false decline alert 206 including one or more identifiers of accountholder 104 and/or account 120 and transmits (C) false decline alert 206 to the upstream parties 106, 108, and/or 118. False decline alert 206 further includes control instructions that cause a computing device (not specifically shown) of the receiving party to activate and incorporate accountholder decline data 201 into their corresponding anti-fraud engines 112, 114, 122, or the decline models used thereby. Updating the decline models, in the example embodiment, counteracts an effect of the declined transaction on at least one future transaction involving accountholder 104 and/or account 120. In the example embodiment, alert computing device 202 transmits false decline alert(s) 206 over the non-transaction message communication channel 204.

In some cases, the transaction was declined by one of the upstream parties, such as merchant 106, acquirer 108, or payment processing computing device 118. Each of these upstream parties, as described above, may implement its own anti-fraud engine 112, 114, 122 with its own decline model(s). Accordingly, only the party that declined the transaction knows the precise reason for the decline. In response to receiving false decline alert 206, the particular upstream party (shown as merchant 106 in FIG. 1) that declined the transaction may transmit (D) a message 208 back to alert computing device 202, message 208 including a decline reason code associated with the declined transaction. The decline reason code indicates the reason the transaction was declined (e.g., bad authorization details, unable to authenticate, rigorous anti-fraud/decline models, etc.). Alert computing device 202 then transmits (E) a notification message 210 to issuer 102, notification message 210 including the decline reason code. Notification message 210 may further include control instructions causing an issuer computing device (not specifically shown) of issuer 102 to activate and update one or more records associated with accountholder 104 and/or account 120. For instance, if the decline reason code indicates that the authorization details were inaccurate or outdated, issuer 102 may update a record associated with account 120 to indicate that the authorization details being used by accountholder 104 are inaccurate or outdated. In response, issuer 102 may initiate communication with accountholder 104 to ensure that accountholder 104 has the proper authorization credentials for future transactions.

In other cases, the transaction was declined by issuer 102. In such cases, the upstream parties 106, 108, 118 receive various transaction messages over network 116, such as decline transaction messages, indicating that issuer 120 declined the transaction. Those upstream parties 106, 108, 118 may interpret (incorrectly) that this decline was the result of a fraudulent transaction and may blacklist accountholder 104 and/or account 120, or otherwise negatively affect the outcomes of decline modelling associated with accountholder 102 and/or account 120. In these cases, alert computing device 202 may not transmit (C) false decline alert 206 to upstream parties 106, 108, 118 (causing those parties to update their decline models) but may also transmit (F) false decline alert 206 to issuer 102. The control instructions in false decline alert 206 cause the issuer computing device (not specifically shown) of issuer 102 to activate and update at least one decline model associated with accountholder 104, and/or to update one or more records associated with accountholder 104 and/or account 120. Such updating may reduce the likelihood that issuer 102 will decline a future transaction and/or may cause issuer 102 to initiate communication with accountholder 104 to ensure accountholder 104 has the proper account details to prevent further future declines (e.g., making sure authorization credentials are up to date, authentication details remain accurate, etc.).

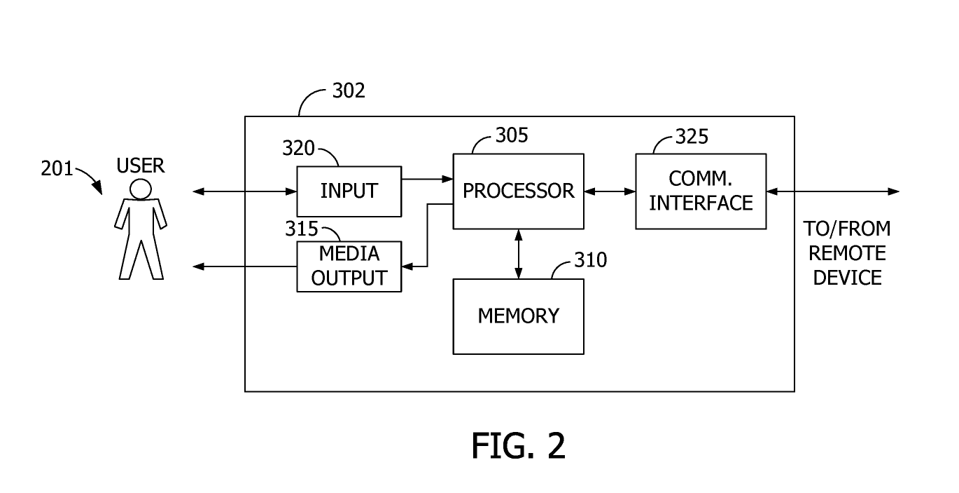

FIG. 2 illustrates an example configuration of a user system 302, such as an accountholder computer device of accountholder 104 (shown in FIG. 1), or computing device(s) associated with any party to transaction processing system 100 (also shown in FIG. 1). In the example embodiment, user system 302 includes a processor 305 for executing instructions. In some embodiments, executable instructions are stored in a memory area 310. Processor 305 may include one or more processing units, for example, a multi-core configuration. Memory area 310 is any device allowing information such as executable instructions and/or written works to be stored and retrieved. Memory area 310 may include one or more computer readable media.

User system 302 also includes at least one media output component 315 for presenting information to a user 301 (e.g., accountholder 104). Media output component 315 is any component capable of conveying information to user 301. For example, media output component 315 may be a display component configured to display component lifecycle data in the form of reports, dashboards, communications, or the like. In some embodiments, media output component 315 includes an output adapter such as a video adapter and/or an audio adapter. An output adapter is operatively coupled to processor 305 and operatively connectable to an output device such as a display device, a liquid crystal display (LCD), organic light emitting diode (OLED) display, or “electronic ink” display, or an audio output device, a speaker or headphones.

In some embodiments, user system 302 includes an input device 320 for receiving input from user 301. Input device 320 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 315 and input device 320. User system 302 may also include a communication interface 325, which is communicatively connectable to a remote device. Communication interface 325 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 310 are, for example, computer readable instructions for providing a user interface to user 301 via media output component 315 and, optionally, receiving and processing input from input device 320. A user interface may include, among other possibilities, a web browser and client application (“app”). Web browsers enable users, such as user 301, to display and interact with media and other information typically embedded on a web page or a website.

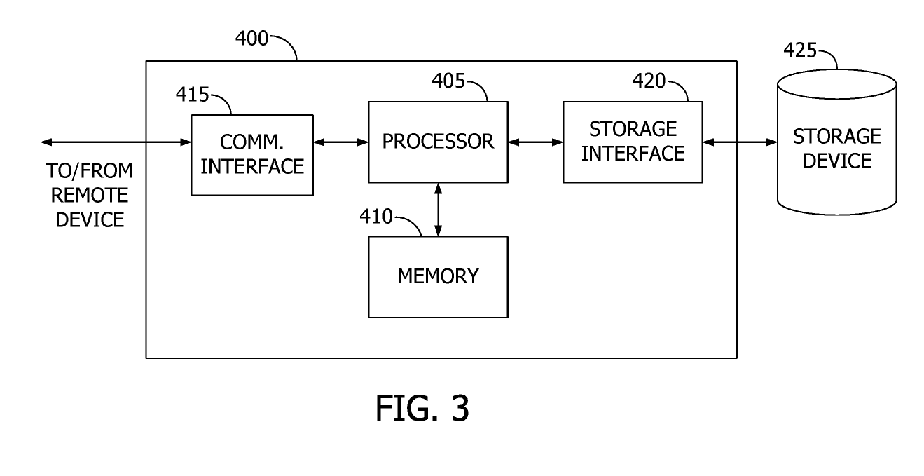

FIG. 3 shows an example configuration of a server system 400. Server system 400 may include, but is not limited to, alert computing device 202 (shown in FIG. 1) and/or computing device(s) associated with any party to transaction processing system 100 (also shown in FIG. 1).

Server system 400 includes a processor 305 for executing instructions. Instructions may be stored in a memory area 410, for example. Processor 405 may include one or more processing units (e.g., in a multi-core configuration) for executing instructions. The instructions may be executed within a variety of different operating systems on the server system 400, such as UNIX, LINUX, Microsoft Windows®, etc. More specifically, the instructions may cause various data manipulations on data stored in storage 425 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 405 is operatively coupled to a communication interface 415 such that server system 400 is capable of communicating with a remote device such as a user system 302 (shown in FIG. 3) or another server system 400. Processor 405 may also be operatively coupled to a storage device 425. Storage device 425 is any computer-operated hardware suitable for storing and/or retrieving data. In some embodiments, storage device 425 is integrated in server system 400. In other embodiments, storage device 425 is external to server system 400. For example, server system 400 may include one or more hard disk drives as storage device 425. In other embodiments, storage device 425 is external to server system 400 and may be accessed by a plurality of server systems 400. For example, storage device 425 may include multiple storage units such as hard disks or solid state disks in a redundant array of inexpensive disks (RAID) configuration. Storage device 425 may include a storage area network (SAN) and/or a network attached storage (NAS) system.

In some embodiments, processor 405 is operatively coupled to storage device 425 via a storage interface 420. Storage interface 420 is any component capable of providing processor 405 with access to storage device 425. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 425.

Memory area 410 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

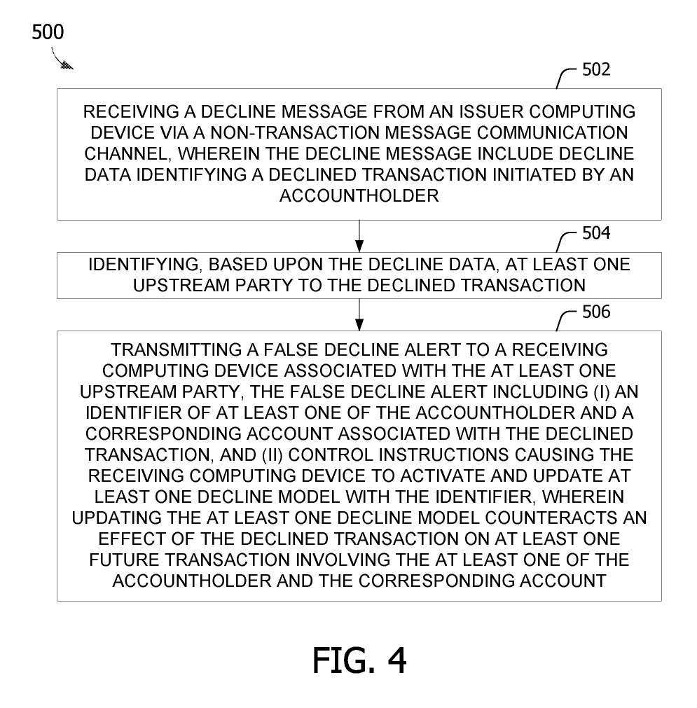

FIG. 4 is an example flow diagram illustrating a method 500 for operating a false decline alert network (e.g., false decline alert network 200, shown in FIG. 1) to disseminate information regarding false declines to all parties to a transaction. Method 500 may be implemented by, for example, alert computing device 202 (shown in FIG. 1).

In the illustrated embodiment, method 500 includes receiving 502 a decline message from an issuer computing device via a non-transaction message communication channel, wherein the decline message includes decline data identifying a declined transaction initiated by an accountholder. Method 500 also includes identifying 504, based upon the decline data, at least one upstream party to the declined transaction. Method 500 further includes transmitting 206 a false decline alert to a receiving computing device associated with the at least one upstream party. The false decline alert includes (i) an identifier of at least one of the accountholder and a corresponding account associated with the declined transaction, and (ii) control instructions causing the receiving computing device to activate and update at least one decline model with the identifier. Updating the at least one decline model counteracts an effect of the declined transaction on at least one future transaction involving the at least one of the accountholder and the corresponding account.

As will be appreciated based on the foregoing specification, the above-described embodiments of the disclosure may be implemented using computer programming or engineering techniques including computer software, firmware, hardware or any combination or subset thereof, wherein the technical effect is to authenticate an accountholder. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of operating a false decline alert network, the method implemented using an alert computing device, the method comprising:
receiving a decline message from an issuer computing device via a non-transaction message communication channel, wherein the decline message includes decline data identifying a declined transaction initiated by an accountholder;
identifying, based upon the decline data, at least one upstream party to the declined transaction; and
transmitting a false decline alert to a receiving computing device associated with the at least one upstream party, the false decline alert including (i) an identifier of at least one of the accountholder and a corresponding account associated with the declined transaction, and (ii) control instructions causing the receiving computing device to activate and update at least one decline model with the identifier, wherein updating the at least one decline model counteracts an effect of the declined transaction on at least one future transaction involving the at least one of the accountholder and the corresponding account.

2. A method in accordance with claim 1, wherein transmitting a false decline alert to a receiving computing device associated with the at least one upstream party comprises transmitting the false decline alert to the receiving device associated with one of a merchant, an acquirer, and a payment processing computing device associated with the declined transaction.

3. A method in accordance with claim 1 further comprising receiving, in response to the false decline alert from a first upstream party to the declined transaction, a decline reason code associated with the declined transaction, the decline reason code indicating a reason the declined transaction was declined by the first upstream party to the declined transaction.

4. A method in accordance with claim 3 further comprising transmitting the decline reason code to the issuer computing device in a notification message, the notification message further including control instructions causing the issuer computing device to activate and update at least one record associated with the at least one of the accountholder and the corresponding account.

5. A method in accordance with claim 1 further comprising transmitting the control instructions to the issuer computing device, the control instructions causing the issuer computing device to activate and update at least one decline model associated with the accountholder.

6. A method in accordance with claim 1, wherein receiving a decline message from an issuer computing device via a non-transaction message communication channel comprises receiving the decline message via at least one of a telephone message, an email message, a text message, and an IP-based message over an API.

7. A method in accordance with claim 1, wherein receiving a decline message including decline data comprises receiving decline data including at least one of the identifier of the corresponding account associated with the declined transaction, a transaction amount of the declined transaction, a date of the declined transaction, a time of the declined transaction, and a merchant with which the declined transaction was initiated.

8. An alert computing device for implementing a false decline alert network, the alert computing device comprising a processor in communication with a memory device, the processor programmed to:
receive a decline message from an issuer computing device via a non-transaction message communication channel, wherein the decline message includes decline data identifying a declined transaction initiated by an accountholder;
identify, based upon the decline data, at least one upstream party to the declined transaction; and
transmit a false decline alert to a receiving computing device associated with the at least one upstream party, the false decline alert including (i) an identifier of at least one of the accountholder and a corresponding account associated with the declined transaction, and (ii) control instructions causing the receiving computing device to activate and update at least one decline model with the identifier, wherein updating the at least one decline model counteracts an effect of the declined transaction on at least one future transaction involving the at least one of the accountholder and the corresponding account.

9. An alert computing device in accordance with claim 8, wherein the at least one upstream party includes one of a merchant, an acquirer, and a payment processing computing device associated with the declined transaction.

10. An alert computing device in accordance with claim 8, wherein the processor is further programmed to receive, in response to the false decline alert from a first upstream party to the declined transaction, a decline reason code associated with the declined transaction, the decline reason code indicating a reason the declined transaction was declined by the first upstream party to the declined transaction.

11. An alert computing device in accordance with claim 10, wherein the processor is further programmed to transmit the decline reason code to the issuer computing device in a notification message, the notification message further including control instructions causing the issuer computing device to activate and update at least one record associated with the at least one of the accountholder and the corresponding account.

12. An alert computing device in accordance with claim 8, wherein the processor is further programmed to transmit the control instructions to the issuer computing device, the control instructions causing the issuer computing device to activate and update at least one decline model associated with the accountholder.

13. An alert computing device in accordance with claim 8, wherein the decline message is received via the non-transaction message communication channel as at least one of a telephone message, an email message, a text message, and an IP-based message over an API.

14. An alert computing device in accordance with claim 8, wherein the decline data includes at least one of the identifier of the corresponding account associated with the declined transaction, a transaction amount of the declined transaction, a date of the declined transaction, a time of the declined transaction, and a merchant with which the declined transaction was initiated.

15. A non-transitory computer readable medium that includes computer executable instructions for implementing a false decline alert network, wherein when executed by an alert computing device comprising a processor in communication with a memory device, the computer executable instructions cause the alert computing device to:
receive a decline message from an issuer computing device via a non-transaction message communication channel, wherein the decline message includes decline data identifying a declined transaction initiated by an accountholder;
identify, based upon the decline data, at least one upstream party to the declined transaction; and
transmit a false decline alert to a receiving computing device associated with the at least one upstream party, the false decline alert including (i) an identifier of at least one of the accountholder and a corresponding account associated with the declined transaction, and (ii) control instructions causing the receiving computing device to activate and update at least one decline model with the identifier, wherein updating the at least one decline model counteracts an effect of the declined transaction on at least one future transaction involving the at least one of the accountholder and the corresponding account.

16. A non-transitory computer readable medium in accordance with claim 15, wherein the at least one upstream party includes one of a merchant, an acquirer, and a payment processing computing device associated with the declined transaction.

17. A non-transitory computer readable medium in accordance with claim 15, wherein the computer-executable instructions further cause the alert computing device to receive, in response to the false decline alert from a first upstream party to the declined transaction, a decline reason code associated with the declined transaction, the decline reason code indicating a reason the declined transaction was declined by the first upstream party to the declined transaction.

18. A non-transitory computer readable medium in accordance with claim 17, wherein the computer-executable instructions further cause the alert computing device to transmit the decline reason code to the issuer computing device in a notification message, the notification message further including control instructions causing the issuer computing device to activate and update at least one record associated with the at least one of the accountholder and the corresponding account.

19. A non-transitory computer readable medium in accordance with claim 15, wherein the computer-executable instructions further cause the alert computing device to transmit the control instructions to the issuer computing device, the control instructions causing the issuer computing device to activate and update at least one decline model associated with the accountholder.

20. A non-transitory computer readable medium in accordance with claim 15, wherein the decline data includes at least one of the identifier of the corresponding account associated with the declined transaction, a transaction amount of the declined transaction, a date of the declined transaction, a time of the declined transaction, and a merchant with which the declined transaction was initiated.
